(19) United States
(12) Patent Application Publication
(10) Pub. No.: US 2007/0081419 A1
(43) Pub. Date: Apr. 12, 2007

(54) PORTABLE DC MOTOR DRIVEN LABORATORY ASSEMBLY FOR UNINTERRUPTED STIRRED PROCESSES

(76) Inventor: Duen Gang Mou, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 11/538,066

(22) Filed: Oct. 3, 2006

(30) Foreign Application Priority Data
Oct. 7, 2005 (TW) 94135264

(51) Int. Cl. B01F 7/20

(52) U.S. Cl. 366/251; 366/307; 366/601

(57) ABSTRACT

By coupling small laboratory bench-top mixer/stirrer or stirred tank reactor with a small portable low voltage DC motor for agitation power, these laboratory devices become portable with uninterrupted power supply and without compromising their continuous operation and high power input capability. This type of small portable DC motor is commercially available, of the consumable type and powered by line power adaptor, car battery or a 12-volt DC battery. Together with an innovative open frame design, this small portable generic stirred reaction device can also achieve mass-production economy and personalized convenience.

### BACKGROUND OF THE INVENTION

Mechanically stirred reaction device usually is composed of a reaction vessel, a reaction mixture, a stirring blades assembly and a motor. Mechanically stirred reactions and devices are long practiced in the chemical engineering field—a unit operation called “agitation and mixing”. Small bench-top device of 20 liter or less in volume may involve a glass beaker, a plastic bucket or a carboy, a set of impeller blades or a magnetic stirring bar coupled to a stirring motor. Alternatively, arrays of Erlenmeyer flask reactors of various sizes may be mixed on a shaker table when a number of reactors are required. Larger manufacturing devices of 100 s to 100,000 s liter in volume are most often some kind of tank or vessel, usually cylindrical in form, with stirrer motor mounted on top. The top of the vessel may be open to the air, but more usually it is closed and with a closed top. Scaled down version of a standardized design, usually in a size from liters to hundreds of liters, is used in the laboratory or pilot plant for research, development and scale up of various physical, chemical, biochemical and biological reactions.

The objects of liquid agitation include (McCabe, Smith and Harriott, Unit Operations of Chemical Engineering, 7^{th} Ed., Chapter 9, McGraw-Hill International Ed., 2005):
1. Suspending solid particles.
2. Blending miscible liquids, for example, methyl alcohol and water.
3. Dispersing a gas through the liquid in the form of small bubbles.
4. Dispersing a second liquid, immiscible with the first, to form an emulsion or a suspension of fine droplets.
5. Promoting heat transfer between the liquid and a coil or jacket.

Often one agitator serves several purposes at the same time, as in the fermentation production of an antibiotic. In an antibiotic fermentation vessel, swarms of fine air bubbles are dispersed through the liquid nutrients in which solid metabolizing filamentous biomass are suspended, promoting mass transfer at the gas-liquid and liquid-solid interfaces.

Stirrer speed in round per minute (rpm) and its rotation torque in kg_{f}-cm are two performance parameters of the motor, whereas power drawn per unit liquid volume through the rotating blades is a composite performance parameter of all five mixing objectives listed above. In a rough qualitative way, it is said that 0.5-1 hp power drawn per 1,000 gal of liquid (0.1-0.2 watt/liter or W/L) gives “mild” agitation, 2-3 hp per 1,000 gal (0.4-0.6 W/L) gives “vigorous” agitation, and 4-10 hp per 1,000 gal (0.8-2.0 W/L) gives “intense” agitation (McCabe, Smith and Harriott, 2005). The critical power drawn of 1.5 hp per m³ of broth for successful scale up of viscous antibiotic fermentation by filamentous microorganism, i.e., 1.1 W/L, also is in the “intense” agitation region (Aiba, Humphrey and Millis, Biochemical Engineering, 2^{nd} Ed, Chapter 8, Academic Press, New York and London, 1973).

Because of limited volume and reduced engineering significance, stirred tank reaction device with intense agitation under 1 liter in volume is not widely available. Contained reactions of 1 liter or less in volume usually are conveniently done using shaken flasks and shaker table, even though their mixing intensity rarely matches that of a well stirred tank. Between a shaken flask and a stirred tank reactor the difference in oxygen transfer rate (OTR) can be an order of magnitude or higher −20 mmol O₂/L hr in 500 ml rotary shaken flask with 20% culture volume at 250 rpm and 50 mm throw (Pirt, Principle of Microbe and cell Cultivation, p. 103-105, John Wiley & Sons, New York, 1975) vs. 100 to 1,000 mmol O₂/L hr in most laboratory liters size stirred and air-sparged tank fermentation reactors (Wang et al., Fermentation and Enzyme Technology, p. 182, John Wiley & Sons, New York, 1979). Shaken flask is limited here by its surface aeration and low power drawn per unit volume. Hence stirred reactor of 1 liter or less with high power input would be a major step forward if it can be made widely available like shaken flask.

Due to depletion of low solubility gaseous substrate, uncontrolled growth of polymer chain length or liquid viscosity and the consequent runaway temperature control, or breakdown of emulsion or homogenized two immiscible phases, it often is detrimental to have mixing operation interrupted or suspended before its time. However, interruption or suspension of proper agitation often is unavoidable at laboratory R&D stage due to limited mobility or limited portability of the mixing or stirred reaction equipment and the necessary transfer of reaction sample, content, scale or operator between locations during experiment. It therefore would be a major improvement if high power agitation or mixing can be made portable, i.e., to move with the experiment and/or the experimenter.

One example is the use of shaken flask culture in providing mixing and surface aeration for oxygen transfer in laboratory aerobic fermentation study. Shaken flask culture device is hardly portable with its heavy shaker table and line power requirement. Once an ambient flask culture is removed from the shaker table, even oxygen saturated culture broth may see oxygen depletion within a minute—typically a saturated solubility of 0.25 mM will sustain a culture of oxygen uptake rate of 40 mmol/L-hr for less than 0.25(mmol/L)÷40(mmol/L-hr)×60(min/hr)=0.37 min or 22 sec. Uninterrupted oxygenation therefore cannot easily be brought with the flask to a distant location of a building, a campus, a plant site or a field or farm where an experiment awaits active and well oxygenated culture. This period of agitation suspension or oxygen starvation gives rise to experimental variation and uncertainty and is still an unsolved problem in the lab after all these years. Commercially available small 1 liter or sub-liter size stirred tank reactors may be capable of intense mixing, but are still too expensive to be widely used for generic laboratory purposes, and are not yet known to be easily portable.

All commercially available portable laboratory stirring devices today involve small battery-powered motor with only sufficient power to move a small magnetic stirring bar. They include Fisher Scientific's Portable EZ-BOD Tester, Cole Parmer's Battery-Powered Magnetic Stirrer, and Sienco's No. DP443 High Efficiency Portable Mixer. Their primary function is to stir and mix a small amount of liquid sample, usually less than 100 milliliter (ml), in order to take a reliable pH or dissolved oxygen probe reading, or to prepare a small batch of reagent solution. Scientific literature and Google search revealed the use of similar low power drawn DIY device in field determination of ferrous ion oxidation rates in acid mine drainage using a continuously stirred tank reactor (Kirby and Brady, Field determination of Fe⁺⁺ oxidation rates in acid mine drainage using a continuously stirred tank reactor, Applied Geochemistry, 13(4): 509-520, 1998). Researchers here adopted portable electric drill's battery pack as well as 12-volt car battery, small AC motor, DC/AC converter and a stirrer to move the water sample in a surface-aerated open bath. The measured oxygen uptake rates in the range of 0.0036 to 11.8 mmol/L-hr were much lower than the shaken flask figure quoted earlier. It was therefore still the mild agitation type and meant only for intermittent operation.

Intense (i.e., with power drawn up to 2 W/L) and continuous mixing operation in small laboratory reaction vessel of 1 liter or less in volume using portable stirring motor is therefore highly desirable for its move-with-the-experiment portability. Ideally, they should be easy to acquire like a shaken flask for high throughput use, but with power drawn, impeller shear and gas bubble holdup like a standard stirred tank reactor. Portability and higher performance therefore would be highly desirable improvements over prior small generic laboratory stirred reactors.

Extensive search of international patents, scientific literature and Internet content databases reveal no prior design, use or application of such devices. Known laboratory chemical reactor suppliers including Ace Glass, Kimble/Kontes Glass and Mettler Toledo, as well as known laboratory bioreactor suppliers including New Brunswick Scientific, Applikon, Sartorius B. Braun, Bellco, Broadley-James and Infors also do not carry or mention any product of the aforementioned features.

The same is found true upon further search for existing portable small motor-driven laboratory apparatus, such as mechanical stirrer/mixer, magnetic stirrer/mixer, mixing shakers and rollers, peristaltic and circulating pumps, with high power input and can move with the experiment and the experimenter. The small portable DC motor specified in this invention together with appropriately rated rpm-reduction gear and torque and matching couplings can render them all portable as well as capable of continuous and UPS duty cycles.

### BRIEF SUMMARY OF THE INVENTION

The primary portability objective of the invention is achieved through the use of small low cost and low voltage portable DC motors for agitation power. In summary, the portable DC motor driven laboratory assembly for uninterrupted stirred processes comprises at least one stirred process unit. Each of the stirred process units comprises a vessel having a capacity of 0.1˜20 liters; an agitator assembly having an agitator shaft and a plurality of impellers provided at an end of the agitator shaft; a 12-volt DC motor connected to the agitator assembly, the DC motor having a rated power output not exceeding 50 watt; a head-plate assembly disposed at a top side of the vessel for supporting the agitator assembly and the DC motor; and a 12-volt DC source such as a 12-volt battery for supplying power to the DC motor.

The vessel of each of the stirred process units can be used for mixing or as a stirred reactor. A tall form glass beaker without spout, a carboy, or a glass serum bottle, etc., all can be used as the vessel.

Preferably, the power input delivered by the DC motor to a liquid phase inside the vessel is in 0.8˜2.0 watt/liter.

The stirred process unit may also include a line power AC/DC adapter to supply power to the 12-volt DC motor as an alternative to the 12-volt battery. Moreover, an uninterrupted power supply (UPS) unit may be added between the DC motor at one end and the 12-volt DC battery and the AC line power at the other end to warrant uninterrupted power supply to the DC motor.

In an embodiment according to the present invention, each stirred process unit further comprises inside the vessel a removable baffle assembly having a plurality of vertically positioned baffle plates symmetrically spaced apart, each baffle plate being hand-bendable and having a silicone tubing provided at a top end to function as a brake lining for the baffle plate.

Various means are provided to carry and move the stirred process units around. In the simplest form, a plastic measuring pitcher capable of holding the vessel therein can be used as a protective shield or a hand mobile carrier. Alternatively, a wheeled vehicle with a rack for holding the stirred process units is provided.

Use of small portable or battery driven motor is nothing new. However, most non-laboratory devices are designed and made for short or intermittent duty cycles, and not for continuous long term operation. Selection and testing of lightweight and portable DC motor for continuous intense agitation loading is therefore essential for successful application of this invention.

Said stirring device in this invention includes a battery and line power driven portable DC motor with accompanying detachable motor mount and agitator coupling, an agitator shaft and blades assembly, and when needed, a reaction vessel, a removable baffle-plate-assembly, a multi-penetration semi-solid and non-metal stopper as vessel head-plate, and a hand tighten top and bottom ring-clamp and gasket/O-ring assembly for secure airtight seal. It serves as a small portable generic stirring mixer and/or a stirred tank reactor (STR), and is meant to satisfy all mixing functions and the accompanying, if any, physical, chemical, biochemical, biological and fermentation reactions where uninterrupted mixing is critical.

The small portable DC motor specified in this invention together with appropriately rated rpm-reduction gear, torque and matching couplings can render all motor-driven small laboratory apparatus, such as mechanical stirrer/mixer, magnetic stirrer/mixer, mixing shakers and test tube rollers, peristaltic and circulating pumps, portable as well as capable of continuous and UPS duty cycles.

### BRIEF DESCRIPTION OF THE DRAWINGS

FIG. 1 is a perspective view of the small portable stirred process unit illustrating the top-mounted agitator and the small portable DC motor with the mixing/reaction vessel (FIG. 1A) and without the mixing/reaction vessel (FIG. 1B).

FIG. 2 is an exploded view of the small portable stirred process unit without the top-mounted small portable DC motor.

FIG. 3 exemplifies the portable and personal nature of the small stirred process unit by carrying it, hold-and-stabilizing it (on a bench-top) and shielding it inside a transparent plastic measuring pitcher typically found in a lab.

FIG. 4 illustrates stand-alone (FIG. 4A) and wired basket mount (FIG. 4B) operation of the small stirred process unit for flat surface.

FIG. 5 illustrates one way to carry the small portable stirred reaction device with gassing option for mobile or field use.

FIG. 6 illustrates ways to shelf-mount (FIG. 6A) and wall-mount (FIG. 6B) a plurality of the small stirred process units inside a lab or a utility vehicle.

FIG. 7 illustrates one way to mount the small stirred process unit for water-bath incubator use.

FIG. 8 illustrates the open frame design and free hand placement of the removable baffle plates inside a commercially available tall form glass beaker.

FIG. 9 illustrates the open frame design of the airtight and flanged silicone head-plate with an integral flange gasket and an O-ring seal to fit commercially available tall form glass beakers of slightly different or off-spec opening diameter.

### DETAILED DESCRIPTION OF THE INVENTION

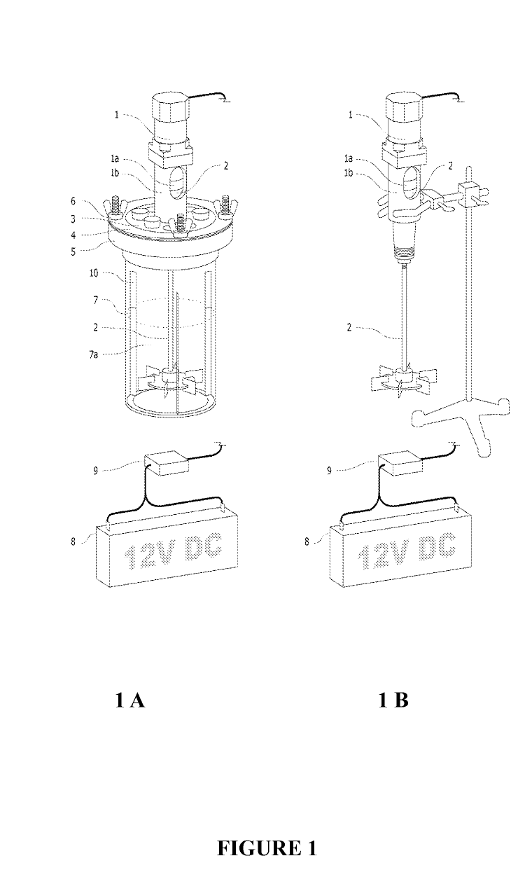

The preferred embodiments of the small portable DC motor driven laboratory assembly for uninterrupted stirred processes according to the present invention are now described with reference to FIGS. 1-9. As illustrated in FIG. 1A, the portable laboratory assembly comprises at least one stirred process unit each comprising a small portable DC motor 1 coupled to an agitator 2 in a mixing/reaction vessel 7 with content 7a and a head-plate assembly 3/4/5/6, and is powered by a multiple DC output power adapter 9 connected to either a 12-volt DC battery 8 or 100-240 V AC line power (not shown). In FIG. 1B, the stirred process unit is shown without the vessel 7.

Since the present invention addresses generic laboratory mixing and agitation function, further description will focus only on the small portable DC motor, its working example of continuous operation and high power input, the open frame design for mass production economy, and its enhanced portability.

(1) Portable DC Motor

Small 12 or 24 volt low voltage OEM/ODM DC motors from several watts to 50 watts, capable of 1,000 or higher rpm, 0.3 kg_{f}-cm or higher torque, weigh less than 1,000 g and have circumferences no more than 80 mm across are commercially available. They may not have enough power to replace motors with a rated power output of tens to hundreds of watt for laboratory and pilot plant stirred tank reactors with a size of liters to tens of liters, but are certainly capable of portable high power mixing, up to 2 W/L, for smaller generic laboratory vessels or reactors. The small footprint of the motor is ideal for top-mounted agitator, because it leaves more room on the head-plate 3 for reagents and sensor entry ports. Its light weight further helps achieve system portability. Their rated output of up to 50 watt is suitable for vessels up to 20 L in volume.

Three commercial models of DC motor meeting above criteria were tested and evaluated for continuous operation which is critical for successful application of this invention under high agitation loads (EXAMPLE 1, 2 and 3):

Type A: 24 VDC/15 W/3000 rpm/brushless (with rpm feedback control),

Type B: 24 VDC/7.6 W/2000 rpm/carbon-brush, and

Type C: 12 VDC/7.7 W/2000 rpm/carbon-brush.

Shown here are rated voltages and rated power outputs and the rpm figures for Types B/C are rpm figures at no load. Their effective diameters are all within 45 to 55 mm and weights 250 to 500 g. They are connected to the agitator 2 through conventional means—either through a quick detachable mounting rack 1b and a coupling 1a (FIG. 1), or through other conventional means for versatile bench-top and field applications.

(2) Agitator Assembly

For better portability, a 6-mm agitator shaft 11 was tested. The agitator shaft 11 comes with matching stainless steel bearing pair (inside the bearing cartridge 12) and carbon/ceramic mechanical seal 13, 13a and 14. Two types of single 6-blade impeller 19 were used to test impeller power drawn (EXAMPLE 1, 2 and 3)—Type A is a 38 mm diameter modified 6-blade paddle-turbine with 10 mm blade-height, and Type B a 50 mm diameter 6-blade disk-turbine with slightly curved blades also of 10 mm height. Due to the larger impeller diameter and hence higher power drawn, Type B impeller was used to test all three motors. The clearance of the impeller from the bottom of the vessel 7 was kept at 30-40 mm.

(3) Open Frame Design

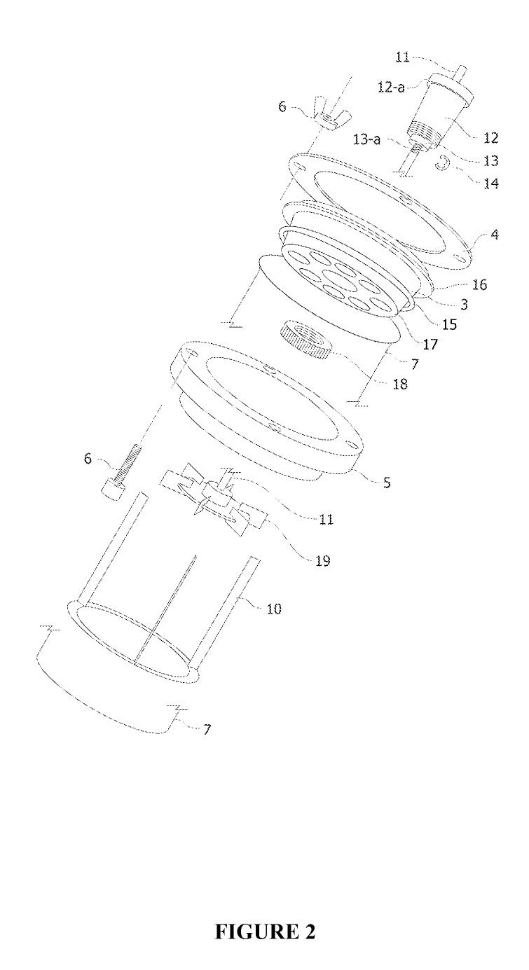

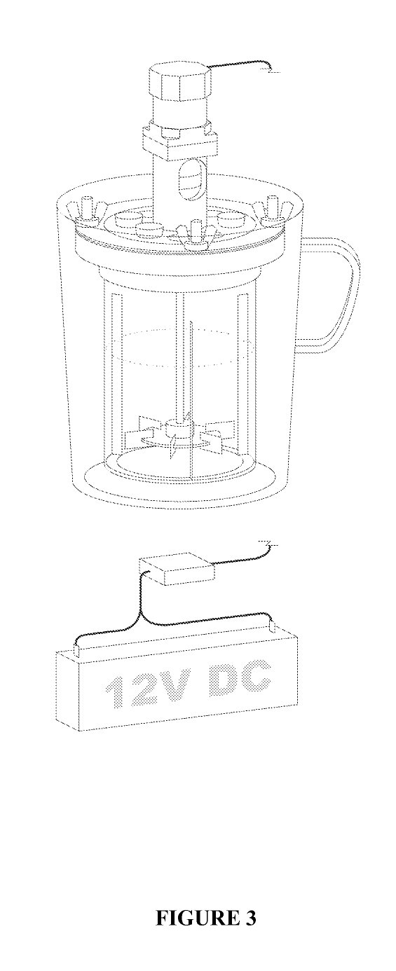

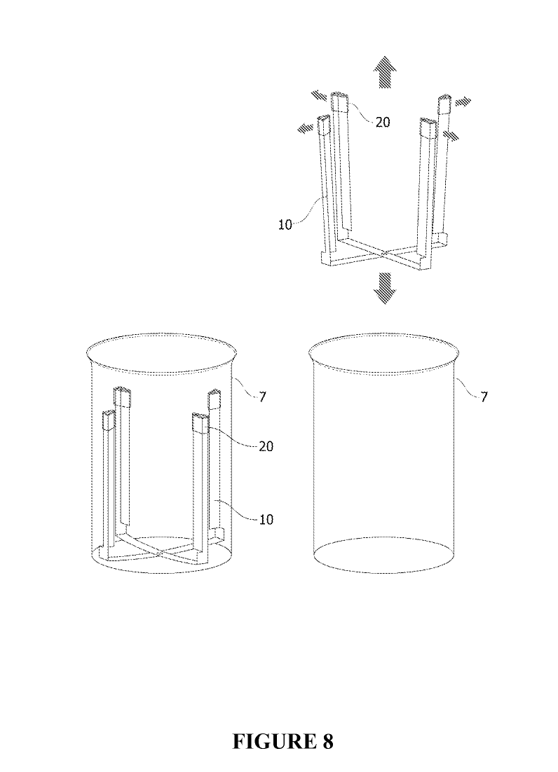

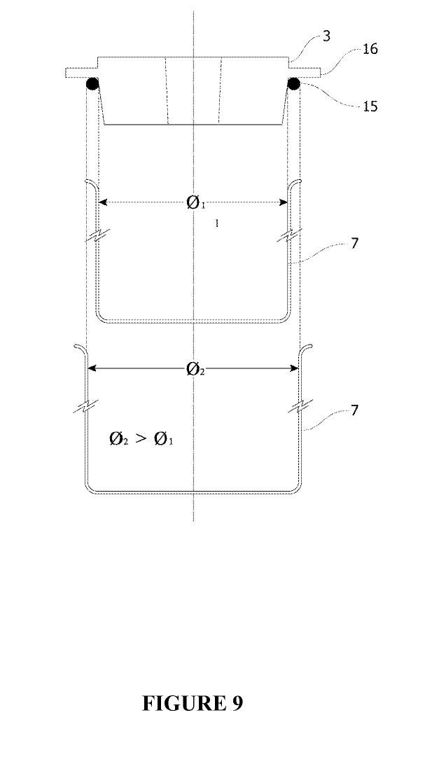

The concept of open-frame design is for user friendliness, mass production and mass circulation economy. Off-the-shelf components and user DIY convenience are therefore designed into the present invention. For example, a tall form glass beaker of various sizes without pouring spout from Corning, Kimble Kontes and Schott Duran catalogs can be used as the vessel 7 (FIG. 1A and FIG. 2); an everyday laboratory plastic (polyethylene, polypropylene, polycarbonate and the likes) measuring pitcher can be used as a protective shield stand and mobile hand carrier (FIG. 3); a tall form glass beaker vessel 7 of slightly different size or off-spec opening diameter (Ø1 and Ø2 in FIG. 9) can be fit with a head-plate 3, an integral flange gasket 16 and an O-ring seal 15. Besides, the stirred process unit may further comprise a hand-bendable (to fit vessel inner circumference) and removable (shown by two big arrows in FIG. 8) spring-fit baffle plates 10, which are precision cut/folded and spot welded from thin sheet stainless steel (FIG. 8). By taking advantage of the spring force (shown by four small arrows in FIG. 8) of the sheet stainless steel, silicone-tubing sections 20 can be added to the steel baffle plates 10 as brake linings against the inner wall of the vessel 7 to prevent baffle slippage under high agitation power. These foldable sheet metal baffle plates 10 can be added in multiples of two, such as 6, 8 or 10, for larger vessel or narrower baffle width design. This invention is tested on one-liter Corning 1040, Kimble Kimax 14020 and Schott Duran 21117 beaker vessels. They have an inside diameter about 85-90 mm and height 180-185 mm. In the working example, three make-shift Plexi-glass baffles (instead of the foldable sheet metal baffle plates) of 10 mm wide, 2 mm thick and 120 mm high were cut and attached 120 degree apart near the inner wall of the vessel 7 using two top and bottom 1.5 mm diameter stainless steel spring wires (see FIGS. 2 and 3).

As shown in FIG. 2, an inert rubbery or plastic head-plate 3 is used instead of the usual stainless steel for lightweight and easy handling. These may include silicone rubber, natural rubber, polypropylene, nylon, Teflon and the like. To validate its use in bioprocess applications, the working example uses a custom-made silicone rubber head-plate 3 with an integral flange gasket 16 from a steel mold for the selected glass vessel 7 (FIG. 2). Other than a center agitator entry port (with 24/40 standard taper ground joint dimension), there are eight additional ports 17 of 6 to 20 mm in diameter for batching, seeding, sampling, feeding, air inlet/outlet, and electrodes for monitoring temperature, pH, dissolved oxygen, etc. Soft but semi-rigid silicone head-plate 3 not only forms good seal with the vessel 7 through the integral flange gasket 16 and the O-ring seal 15. It also holds the portable DC motor 1 and the agitator 2 through a bearing housing 12, top locking cap 12a and bottom locking cap 18. The head-plate 3 is further provided with a top fastening stainless steel ring 4, a plastic (polypropylene, nylon, Teflon and the like) bottom fastening ring holder 5 and a nuts and bolts set 6.

(4) Portability

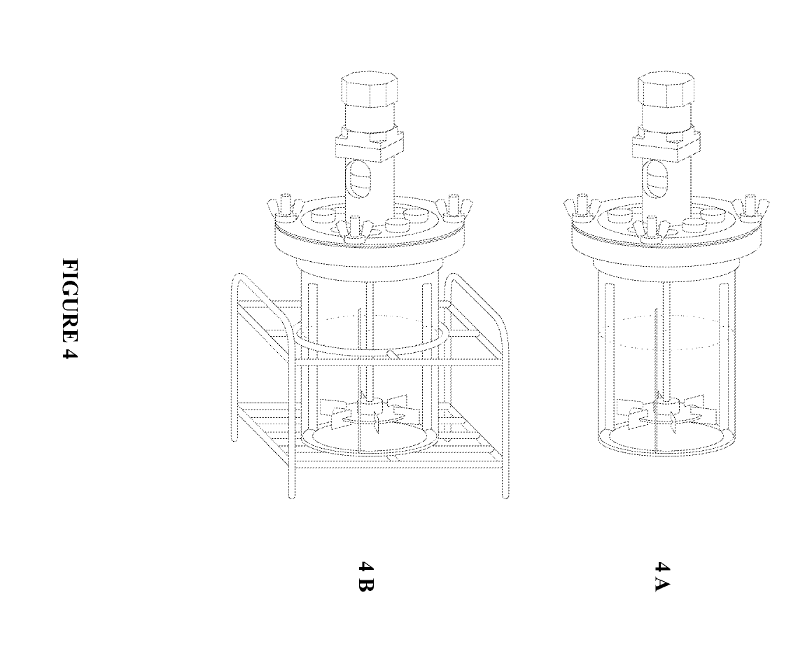

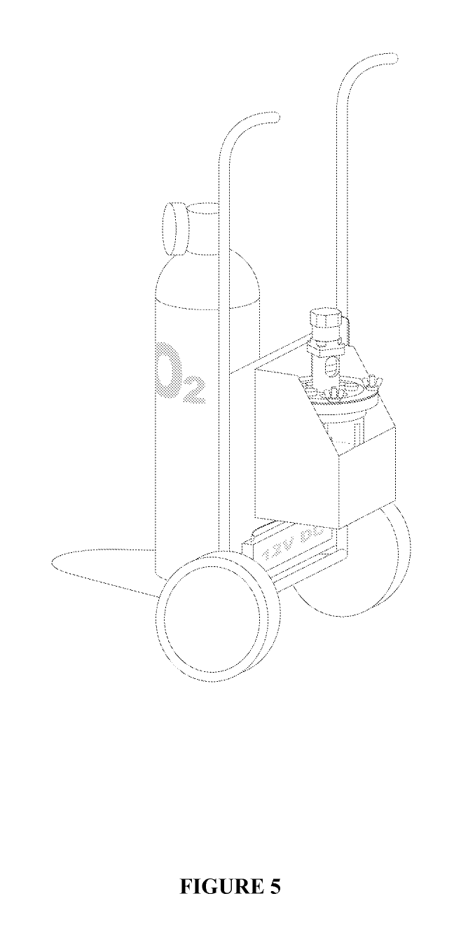

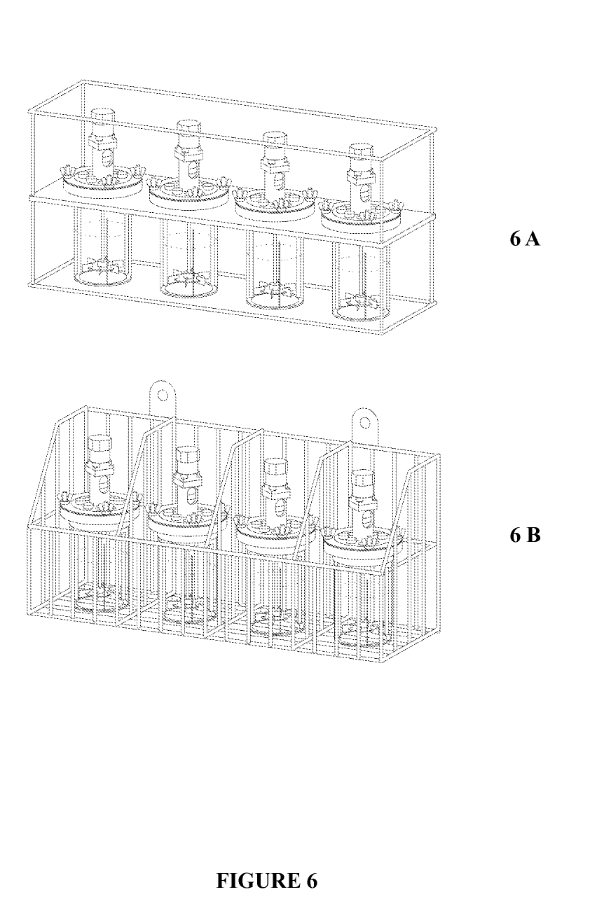

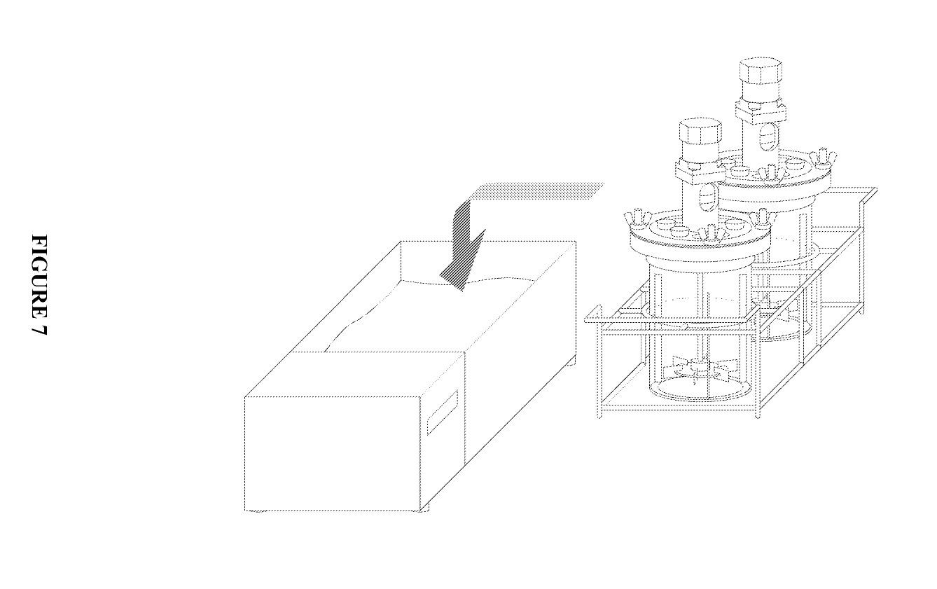

Since portability means all location application, a holder and a stand would make a safer, more mobile and secured operation with one or multiple stirred reaction units. Examples may include being held inside a protective plastic pitcher with handle (in and out of a steam autoclave) (FIG. 3), standing alone (FIG. 4A) or in a stainless steel wired stand on bench-top (FIG. 4B), being transported on a push-cart (FIG. 5), being wall-mounted on shelves (FIG. 6A) or inside a wired rack (FIG. 6B), or being placed in water-bath incubators (FIG. 7). Other than bench-top and water-bath, appropriate locations may include regular and carbon dioxide incubators, incubator rooms, and all ambient, plant, mobile and field sites.

Portability is further enhanced using low cost small wattage off-the-shelf multiple DC-volt (DCV) output power adaptor 9 for easy motor speed control with 100-240 VAC line or 12 VDC battery 8 input (see FIG. 1). This is particular beneficial for mobile or field applications. Battery power compatibility also make UPS backup practical—a fully charged light weight low Amp-hr rating lead battery is good for hours of motor backup during line power suspension. A 2.1 Amp-hr 12 V battery lasted more than 12 hr for a 50 mm diameter 3-blade marine impeller at 90-plus rpm, and more than 3 hr for above Type A impeller at 1000-plus rpm. When connected to the portable DC motor, multiple DCV outputs conveniently produce multiple speed choices (because motor speed is proportional to DC volt input)—a feature often required for reaction and process study. We used adaptor giving 3/4.5/6/7.5/9/12-volt DC outputs and they produced agitator rpm from 200 to 1500 using above Type C motor and Type A impeller. This rpm range compares favorably with similar size high agitation intensity bench-top reactors or fermentors on the market. A 12-volt DC automobile battery power adapter with similar switchable multiple DCV outputs is also available commercially for field application.

As a result of the present invention, the working example device (FIG. 3) including a motor and a 2-L plastic pitcher shield weighs less than 2 kg empty—substantially less than the 10 kg or so similar-sized device on the market. This is why the present invention is considered small, portable and personal—so much so the entire assembly can fit in your palm and be put together and taken apart by hands.

### EXAMPLE 1

Power Input (W/L) of Motor A is tested under non-gassed condition with impeller diameter and rpm as operation variables. The result with and without baffles is listed below together with the liquid volume tested.

| motor rpm | impeller A without baffles | impeller B with baffles |
|---|---|---|
| (liquid & volume) | TSB 550 ml | Water 700 ml |
| 300 | not tested | 2.5 |
| 600 | 2.8 | 5.0 |
| 900 | 3.6 | 10 |
| 1200 | 4.2 W/L | 19 W/L |

### EXAMPLE 2

Power Input of Motor B is tested with gassed or non-gassed, impeller diameter, with or without baffles and rpm as operation variables, and the result is listed below together with liquid volume tested.

| | impeller A | | | impeller B |
|---|---|---|---|---|
| motor | without | impeller A | impeller B | with baffle |
| rpm | baffles | with baffles | with baffle | & aeration |
| (liquid) | TSB | Water | Water | Water |
| (volume) | 550 ml | 650 ml | 700 ml | 700 ml |
| 300 | 2.1 | 1.6 | 2.7 | 2.0 |
| 600 | 2.8 | 3.2 | 4.7 | 4.9 |
| 900 | 4.0 | 5.4 | 9.9 | 9.3 |
| 1200 | 5.0 W/L | 8.8 W/L | 19 W/L | 16 W/L |

### EXAMPLE 3

Power Input of Motor C is tested under non-gassed condition with impeller diameter, with or without baffles and rpm as operation variables, and the result is listed below together with liquid volume tested.

| motor rpm | impeller A, without baffle | impeller B with baffle |
|---|---|---|
| Liquid and Volume | TSB 550 ml | Water 700 ml |
| 300 | 1.9 | 1.9 |
| 600 | 3.5 | 4.8 |
| 900 | 4.0 | 11 |
| 1200 | 4.2 W/L | 20 W/L |

TSB in above Tables stands for Triptic Soy Broth, a nutrient medium commonly used for culturing microorganisms. In order to compare power input at the same rpm, all motor rpm and power input are interpolated figures from experimental data. Motor rpm were measured using a non-contacting photo-optic tachometer. Motor power drawn per unit volume at measured rpm were calculated from the product of set DC volt V value and current ampere I drawn measured with a regulated power supply and divided by liquid volume v in L, i.e., VI/v, and are expressed as watt per liter, W/L.

As one would expect, the three EXAMPLES above of the present invention show that agitation power drawn is a function of rpm, impeller dimension, baffles and aeration, but not of motor selection. The DC motors selected have a rated power efficiency of 40-60%, and after subtracting additional system friction loss from bearings, agitator-motor coupling and mechanical seal, one would expect an overall motor energy conversion efficiency of no less than 10%. This gives maximum effective non-gassing power drawn per unit volume by the motors at 19 W×(0.10)÷0.7 L=2.7 W/L, a figure well above the intense agitation range of 0.8-2.0 W/L (McCabe, Smith and Harriott, 2005).

Alternatively, motor power drawn under baffle, non-gassing and turbulent fluid flow (with Reynold Number>10,000) can be calculated using an empirical formula for standard 4-6 flat-blade turbine impeller (McCabe, Smith and Harriott, 2005):
P(W)=5.75×n³ (round per second)×D⁵ (m, impeller diameter)×ρ(kg/m³, fluid density)

Calculated Reynold Number and power drawn (W) for impeller A and B are shown below.

| | impeller A | impeller A | impeller B | impeller B |
|---|---|---|---|---|
| | Reynold | power drawn, | Reynold | power drawn, |
| rpm | Number | W | Number | W |
| 600 | 14,440 | 0.46 | 25,000 | 1.80 |
| 1200 | 28,880 | 3.65 | 50,000 | 14.4 |

The calculated power drawn may be slightly over estimated due to air entrapment at high rpm in the EXAMPLES. It nevertheless supports the statement above about measured power drawn—that all three small DC motors in the EXAMPLES have maximum effective non-gassing power drawn per unit volume well above the intense agitation range of 0.8-2.0 W/L.

I claim:

1. A portable DC motor driven laboratory assembly for uninterrupted stirred processes, comprising at least one stirred process unit, each of which comprises:
a vessel having a capacity of 0.1˜20 liters;
an agitator assembly having an agitator shaft and a plurality of impellers provided at an end of the agitator shaft;
a DC motor connected to the agitator assembly, the DC motor having a rated power output not exceeding 50 watt;
a head-plate assembly disposed at a top side of the vessel for supporting the agitator assembly and the DC motor; and
a 12-volt DC battery for supplying power to the DC motor.

2. The portable DC motor driven laboratory assembly for uninterrupted stirred processes of claim 1, wherein each stirred process unit further comprises inside the vessel a removable baffle assembly having a plurality of vertically positioned baffle plates symmetrically spaced apart, each baffle plate being hand-bendable and having a silicone tubing provided at a top end to function as a brake lining for the baffle plate.

3. The portable DC motor driven laboratory assembly for uninterrupted stirred processes of claim 1, wherein the head-plate assembly comprises:
a head plate for covering the top side of the vessel, the head plate having at least one through hole for supporting the agitator assembly;
a sealing gasket disposed around the head plate; and
an O-ring for sealing between the sealing gasket and a top rim of the vessel.

4. The portable DC motor driven laboratory assembly for uninterrupted stirred processes of claim 3, wherein the head-plate is made of rubber or plastic.

5. The portable DC motor driven laboratory assembly for uninterrupted stirred processes of claim 1, wherein the vessel of each stirred process unit is a tall form glass beaker without spout.

6. The portable DC motor driven laboratory assembly for uninterrupted stirred processes of claim 1, wherein the vessel of each stirred process unit is a carboy or a glass serum bottle.

7. The portable DC motor driven laboratory assembly for uninterrupted stirred processes of claim 1, wherein each stirred process unit further comprises a plastic measuring pitcher capable of holding the vessel therein for protective or carrying purposes.

8. The portable DC motor driven laboratory assembly for uninterrupted stirred processes of claim 1, further comprising a wheeled vehicle for carrying and transporting the at least one stirred process unit to and between different locations.

9. The portable DC motor driven laboratory assembly for uninterrupted stirred processes of claim 8, wherein the at least one stirred process unit is arranged in a rack on the wheeled vehicle, and the rack with the at least one stirred process unit is removable from the wheeled vehicle to be carried to another location.

10. The portable DC motor driven laboratory assembly for uninterrupted stirred processes of claim 8, wherein the wheeled vehicle is motor-powered.

11. The portable DC motor driven laboratory assembly for uninterrupted stirred processes of claim 10, wherein the at least one stirred process unit is arranged in a rack on the wheeled vehicle, and the rack with the at least one stirred process unit is removable from the wheeled vehicle to be carried to another location.

12. The portable DC motor driven laboratory assembly for uninterrupted stirred processes of claim 1, further comprising a line power AC/DC adapter to supply power to the DC motor as an alternative to the 12-volt DC battery.

13. The portable DC motor driven laboratory assembly for uninterrupted stirred processes of claim 12, wherein the line power AC/DC adapter has a selectable multi-level DC voltage output for controlling speed of the DC motor.

14. The portable DC motor driven laboratory assembly for uninterrupted stirred processes of claim 1, further comprising a 12-volt DC uninterrupted power supply (UPS) unit connected to the DC motor at one end and to an AC line power and the 12-volt DC battery at another end.

15. The portable DC motor driven laboratory assembly for uninterrupted stirred processes of claim 1, further comprising a 12-volt DC uninterrupted power supply (UPS) connected to an AC line power and the 12-volt DC battery at one end and to a 12-volt DC adapter with a selectable multi-level DC voltage output at another end, wherein the 12-volt DC adapter with a selectable multi-level DC voltage output is further connected to the DC motor for controlling speed of the DC motor.

16. The portable DC motor driven laboratory assembly for uninterrupted stirred processes of claim 1, wherein a liquid phase in the vessel receives a power input of 0.8˜2.0 watt/liter.

17. The portable DC motor driven laboratory assembly for uninterrupted stirred processes of claim 1, wherein a 12-volt DC adapter with a selectable multi-level DC voltage output is connected between the 12-volt DC battery and the DC motor for controlling speed of the DC motor.
